(19) United States
(12) Patent Application Publication
(10) Pub. No.: US 2021/0116917 A1
(43) Pub. Date: Apr. 22, 2021

(54) VEHICLE CONTROL SYSTEM, VEHICLE CONTROL METHOD, AND PROGRAM

(71) Applicant: HONDA MOTOR CO., LTD., Minato-ku, Tokyo (JP)

(72) Inventors: Takafumi Hirose, Wako-shi (JP); Naoto Yasuda, Wako-shi (JP); Yuki Oshitani, Tokyo (JP); Susumu Iwamoto, Tokyo (JP)

(21) Appl. No.: 16/970,407

(22) PCT Filed: Feb. 20, 2019
(86) PCT No.: PCT/JP2019/006266

§ 371 Date: Aug. 17, 2020

(30) Foreign Application Priority Data
Feb. 22, 2018 (JP) 2018-029658

(51) Int. Cl. G05D 1/00; G05D 1/02

(52) U.S. Cl. CPC G05D 1/0088; G05D 2201/0213; G05D 1/0276

(57) ABSTRACT

Provided is a vehicle control system including an information acquirer (15) that acquires situation information indicating a situation of surroundings of an autonomous vehicle; collectors (153, 526) that collect, from situation information acquired by the information acquirer, first situation information acquired by the information acquirer in relation to a situation satisfying a predetermined condition including that the autonomous vehicle is traveling without any passengers; and controllers (120, 160) that allow the autonomous vehicle to travel in a first travel mode determined in advance for acquiring the first situation information.

### TECHNICAL FIELD

The present invention relates to a vehicle control system, a vehicle control method, and a program.

Priority is claimed on Japanese Patent Application No. 2018-029658, filed Feb. 22, 2018, the content of which is incorporated herein by reference.

### BACKGROUND ART

In recent years, research has been conducted on automatically controlling vehicles. For example, there is known a system that carries a user or a baggage to a destination by using information indicating a cooperation spot with other autonomous vehicles even when an autonomous vehicle becomes unable to travel (for example, see Patent Literature 1).

### Citation List

### Patent Literature

### [Patent Literature 1]

Japanese Unexamined Patent Application, First Publication No. 2015-092320

### SUMMARY OF INVENTION

### Technical Problem

However, autonomous vehicles are expected to be more expensive than vehicles that are not autonomous vehicles because they are provided with each of sensors, cameras and the like for enabling automatic driving, and are expected to improve profitability in addition to convenience. In the related art, although convenience is taken into consideration, profitability has not been sufficiently examined and mechanisms and the like for making a profit by using autonomous vehicles have not been sufficiently examined.

The present invention is achieved in view of the problems described above, and one object of the present invention is to provide a vehicle control system, a vehicle control method, and a program, by which it is possible to expand the range of use of an autonomous vehicle.

### Solution to Problem

A vehicle control system, a vehicle control method, and a program according to the invention employ the following configurations.

(1) A vehicle control system according to an aspect of the invention is a vehicle control system including an information acquirer configured to acquire situation information indicating a situation of surroundings of an autonomous vehicle; a collector configured to collect first situation information from the situation information acquired by the information acquirer; and a controller configured to allow the autonomous vehicle to travel in a first travel mode determined in advance to acquire the first situation information. The first situation information is information acquired by the information acquirer in relation to a situation satisfying a predetermined condition including that the autonomous vehicle is traveling without any passengers.

(2) In the aspect (1), the first travel mode is different from a second travel mode in a state in which a passenger is in the autonomous vehicle.

(3) In the aspect (1), the first travel mode includes allowing the autonomous vehicle to travel without operating air conditioning equipment installed in the autonomous vehicle.

(4) In the aspect (1), the first travel mode includes allowing the autonomous vehicle to travel in a behavior corresponding to a target from which the situation information is acquired.

(5) In the aspect (1), the first travel mode includes waiting a situation until there is no person around the autonomous vehicle and allowing the autonomous vehicle to travel in a behavior for acquiring the first situation information.

(6) In the aspect (1), the predetermined condition includes that at least one of time information and weather information satisfies an environmental condition determined in advance as an acquisition environment of the first situation information.

(7) In the aspect (1), the controller determines the first travel mode on the basis of information received from an external device by using a communicator.

(8) In the aspect (1), the vehicle control system further includes a judger configured to judge whether a collection condition of the first situation information is satisfied, on the basis of the situation information acquired by the information acquirer, and the collector collects the first situation information on the basis of a judgment result of the judger.

(9) In the aspect (8), the judger judges that the collection condition of the first situation information is satisfied when traveling a place where a map indicated by the situation information acquired by the information acquirer is different from a map prepared in advance as a comparison target.

(10) A vehicle control method according to an aspect of the invention is a vehicle control method implemented by at least one computer performing the steps of: collecting, from situation information acquired by an information acquirer that acquires the situation information indicating a situation of surroundings of an autonomous vehicle, first situation information acquired by the information acquirer in relation to a situation satisfying a predetermined condition including that the autonomous vehicle is traveling without any passengers; and allowing the autonomous vehicle to travel in a first travel mode determined in advance to acquire the first situation information.

(11) A program according to an aspect of the invention is a program causing at least one computer to perform the steps of: collecting, from situation information acquired by an information acquirer that acquires the situation information indicating a situation of surroundings of an autonomous vehicle, first situation information acquired by the information acquirer in relation to a situation satisfying a predetermined condition including that the autonomous vehicle is traveling without any passengers; and allowing the autonomous vehicle to travel in a first travel mode determined in advance to acquire the first situation information.

### EFFECTS OF THE INVENTION

According to the aspects of (1) to (11), it is possible to expand the range of use of an autonomous vehicle.

### BRIEF DESCRIPTION OF DRAWINGS

FIG. 1 is a configuration diagram of a vehicle control system 1 according to a first embodiment.

FIG. 2 is a configuration diagram of an information management device 500.

FIG. 3 is a diagram illustrating an example of the content of schedule information 531.

FIG. 4 is a diagram illustrating an example of the content of collection information 532.

FIG. 5 is a diagram illustrating an example of the content of customer information 533.

FIG. 6 is a configuration diagram of a vehicle control device 5 according to an embodiment.

FIG. 7 is a functional configuration diagram of a first controller 120 and a second controller 160.

FIG. 8 is a diagram illustrating an example of the content of condition information 171.

FIG. 9 is a diagram illustrating an example of the content of travel mode information 172.

FIG. 10 is a flowchart illustrating an example of the flow of processing by the vehicle control device 5.

FIG. 11 is a configuration diagram of an information management device 500A according to a second embodiment.

FIG. 12 is a diagram illustrating an example of the content of position information 534.

FIG. 13 is a flowchart illustrating an example of the flow of processing according to the second embodiment.

FIG. 14 is a diagram illustrating an example of a hardware configuration of an automatic driving control device 100 of an embodiment.

### DESCRIPTION OF EMBODIMENTS

### First Embodiment

Hereinafter, an embodiment of a vehicle control system, a vehicle control method, and a program of the present invention will be described with reference to the drawings.

[Overall Configuration]

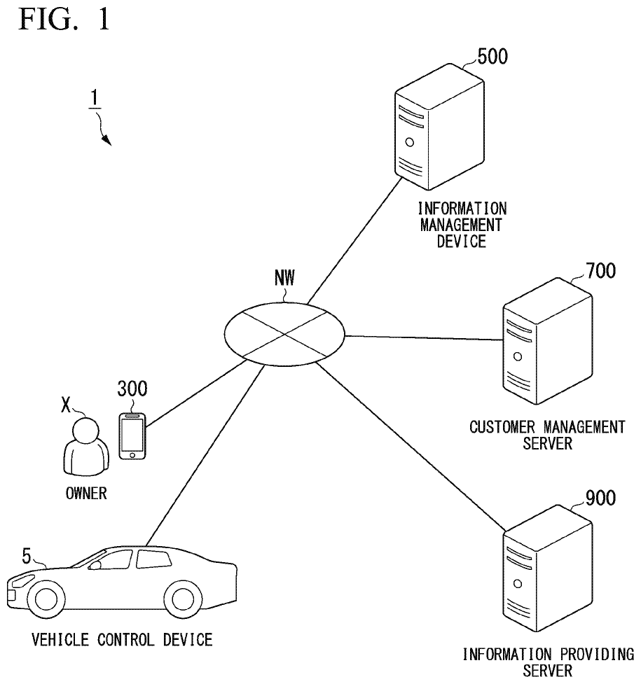

FIG. 1 is a configuration diagram of a vehicle control system 1 according to an embodiment. The vehicle control system 1 is implemented by at least one processor (computer). The vehicle control system 1 includes, for example, at least one vehicle control device 5, at least one terminal device 300, an information management device 500, a customer management server 700, and an information providing server 900. The vehicle control device 5 is an in-vehicle device installed in an autonomous vehicle having an automatic driving function. The autonomous vehicle is, for example, a private car for an owner X. The terminal device 300 is a terminal device owned by the owner X, and is, for example, a portable terminal device having at least a communication function and an information input/output function, such as a mobile telephone such as a smart phone, a tablet terminal, a notebook computer, and a personal digital assistant (PDA). The customer management server 700 is a server managed by a customer who purchases information acquired by the vehicle control device 5. The information providing server 900 is a server that manages information such as weather information and is provided in the vehicle control device 5 and the information management device 500 according to a request.

The vehicle control devices 5, the terminal devices 300, the information management device 500, the customer management server 700, and the information providing server 900 are connected to each other via a network NW, and communicate with each other via the network NW. The network NW includes, for example, some or all of a wide area network (WAN), a local area network (LAN), the Internet, a dedicated line, a wireless base station, a provider, and the like.

Hereinafter, an example of a usage situation of the vehicle control system 1 according to the embodiment will be described. For example, it is assumed that the owner X mainly uses an autonomous vehicle during the day on holidays, but rarely uses the autonomous vehicle on weekdays or at night on holidays. The vehicle control system 1 can use such an autonomous vehicle of the owner X as a mobile resource during a period in which the owner X does not use the autonomous vehicle. For example, the vehicle control system 1 can allow the autonomous vehicle to travel in a state in which there is no passenger in the autonomous vehicle and utilize the autonomous vehicle as a mobile resource that acquires various types of information (hereinafter, written as collection information) by using devices installed in the autonomous vehicle in the state in which there is no passenger in the autonomous vehicle. The content of the collection information may be set by the owner X or according to a request of a customer who purchases information. Note that the usage situation is not limited thereto, and for example, the autonomous vehicle may also be utilized as a mobile resource during a period in which the owner X gets on the autonomous vehicle, leaves his/her home, and stays in a shopping mall which is a destination.

The collection information includes, for example, three-dimensional map information, construction information, map image information, inspection information, location information, and the like. The three-dimensional map information is, for example, map information used in automatic driving. The construction information includes information on roads under construction, information on accidents in lanes or near the lanes, and the like. The map image information is image data or moving data correlated with a map. The inspection information is information used for a predetermined inspection and is information on an object to be inspected. The location information is image data or moving data related to a building having a specified external appearance, a landscape, and the like.

[Information Management Device 500]

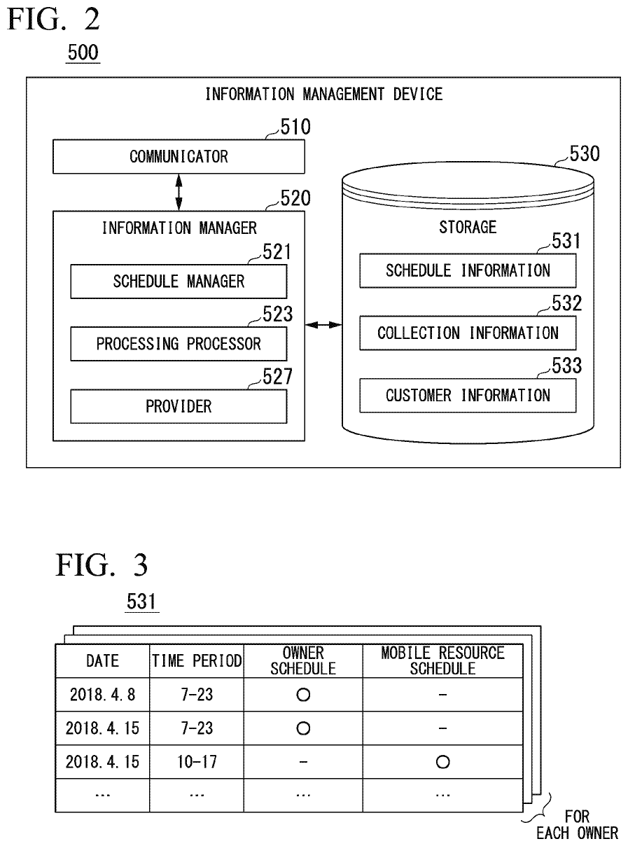

First, the information management device 500 will be described. FIG. 2 is a configuration diagram of the information management device 500. The information management device 500 includes a communicator 510, an information manager 520, and a storage 530. The communicator 510 includes, for example, a communication interface such as a NIC. The storage 530 is, for example, a random access memory (RAM), a read only memory (ROM), a flash memory such as a solid state drive (SSD), a hard disk drive (HDD), and the like. The storage 530 stores, for example, information such as schedule information 531, collection information 532, and customer information 533. The storage 530 may by an external storage device such as a network attached storage (NAS) that can be accessed by the information management device 500 via the network.

The schedule information 531 is information indicating a usage schedule of the autonomous vehicle. FIG. 3 is a diagram illustrating an example of the content of the schedule information 531. As illustrated in FIG. 3, the schedule information 531 is information in which a date is correlated with a time period, an owner schedule, and a mobile resource schedule. A table as illustrated in FIG. 3 is prepared for each owner. The date and the time period are date and time in which the usage schedule of the autonomous vehicle is set. When the owner planes to use the autonomous vehicle, “O” indicating that “schedule has been set” is written in the field of the owner schedule. When it is planned to be used as a mobile resource, “O” indicating that “schedule has been set” is written in the field of the mobile resource schedule. “−” written in the fields of the owner schedule and the mobile resource schedule indicates that no schedule has been set. Note that the owner schedule and the mobile resource schedule may include the content of detailed schedules. The usage schedule may be set by the owner X, or set by the information management device 500 on the basis of the usage schedule set by the owner X.

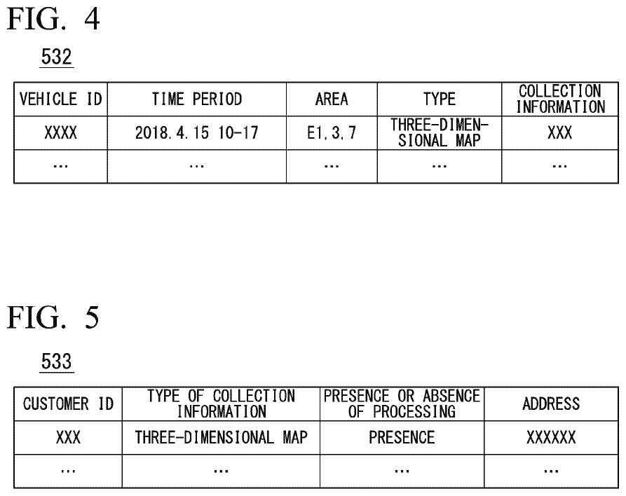

The collection information 532 includes information collected from the autonomous vehicle, and the like. FIG. 4 is a diagram illustrating an example of the content of the collection information 532. As illustrated in FIG. 4, the collection information 532 is information in which a vehicle ID is correlated with a time period, an area, a type, and collection information. The vehicle ID is identification information for identifying each autonomous vehicle. The time period is a time period in which the collection information has been collected. The area is an area where the autonomous vehicle has traveled in a situation where the collection information has been collected. The type is a type of the collection information. The collection information is actual data of the collection information received from the autonomous vehicle.

The customer information 533 includes information on a customer who purchases the collection information. FIG. 5 is a diagram illustrating an example of the content of the customer information 533. As illustrated in FIG. 5, the customer information 533 is information in which a customer ID is correlated with the type of the collection information, the presence or absence of processing, and an address. The customer ID is identification information for identifying each customer. The type of the collection information may be a type name or identification information for identifying each type. The presence or absence of processing is information indicating whether to process the collection information, and is designated by a customer, for example. The address is identification information of the customer management server 700, an e-mail address designated by a customer, and the like.

The information manager 520 includes a schedule manager 521, a processing processor 523, and a provider 527. Some or all of these components are implemented by, for example, a processor such as a central processing unit (CPU) that executes a program (software) stored in the storage 530. Some or all of these components may be implemented by hardware (a circuit unit: including circuitry) such as a large scale integration (LSI), an application specific integrated circuit (ASIC), a field-programmable gate array (FPGA), and a graphics processing unit (GPU), or may be implemented by software and hardware in cooperation.

The schedule manager 521 updates the schedule information 531 on the basis of information received from the vehicle control device 5 or the terminal device 300 by using the communicator 510. Furthermore, the schedule manager 521 may generate the mobile resource schedule with reference to the owner schedule of the schedule information 531 and add the mobile resource schedule to the schedule information 531. For example, the schedule manager 521 may also estimate a pattern on the basis of the past owner schedule and generate the mobile resource schedule on the basis of the estimated pattern.

The processing processor 523 performs processing on collection information to be provided to a customer. For example, when the presence of processing has been set in the “presence or absence of processing” defined in the customer information 533, the processing processor 523 performs processing on the collection information included in the collection information 532. The processing includes, for example, a process of changing to a data format requested by a customer, a process of extracting a difference between information possessed by the customer and the collection information, and the like. With this, information obtained by processing the format requested by the customer, and the like is provided to the customer as collection information, so that it is possible to increase the value of the collection information. On the other hand, collection information that has not been processed may be more versatility.

The provider 527 provides the collection information to the customer by using the communicator 510. For example, on the basis of the “address” defined in the customer information 533, the provider 527 transmits the collection information included in the collection information 532 to the customer management server 700. Note that, when the customer desires processing, the provider 527 transmits the information processed by the processing processor 523 to the customer management server 700 as collection information.

[Vehicle Control Device 5]

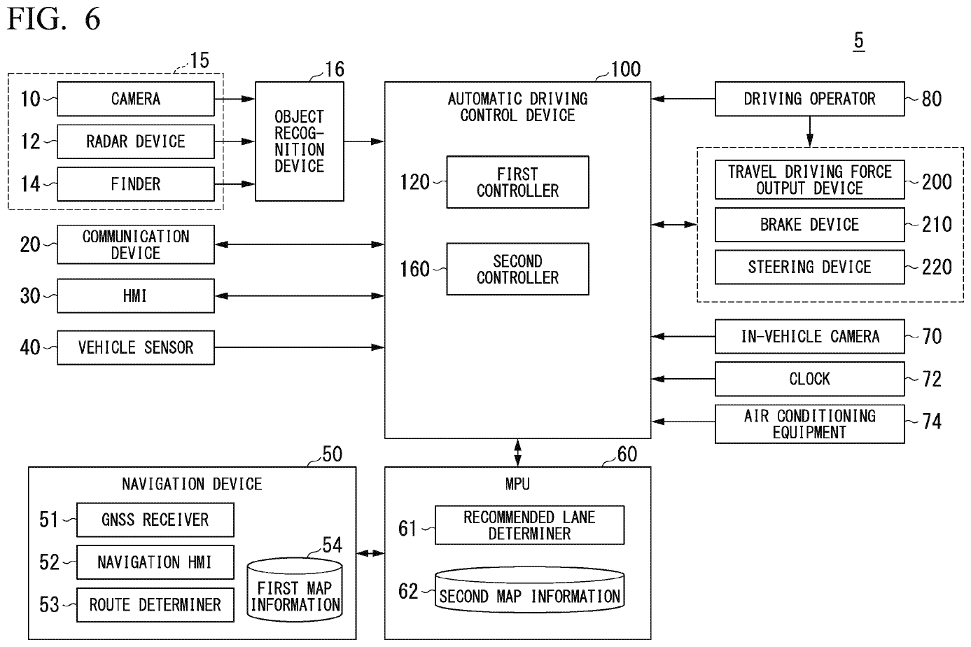

Next, the vehicle control device 5 will be described. FIG. 6 is a configuration diagram of the vehicle control device 5 according to an embodiment. A vehicle, in which the vehicle control device 5 is installed, is a vehicle with two wheels, three wheels, four wheels and the like, for example, and its driving source is an internal combustion engine such as a diesel engine and a gasoline engine, an electric motor, or a combination thereof. The electric motor operates by using power generated by a generator connected to the internal combustion engine or power discharged from a secondary cell or a fuel cell.

The vehicle control device 5 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, an in-vehicle camera 70, a clock 72, an air conditioning equipment 74, a driving operator 80, an automatic driving control device 100, a travel driving force output device 200, a brake device 210, and a steering device 220. These devices and equipment are connected to each other via a multiplex communication line such as a controller area network (CAN) communication line, a serial communication line, a wireless communication network and the like. Note that the configuration illustrated in FIG. 6 is merely an example, and a part of the configuration may be omitted, or other configurations may be added.

Note that the camera 10, the radar device 12, and the finder 14 are an example of an information acquirer 15 that acquires situation information indicating the situation of the surroundings of the autonomous vehicle. Note that the information acquirer 15 is not limited to the configurations of these components and may include a sonar, for example.

The camera 10 is, for example, a digital camera using a solid-state imaging element such as a charge coupled device (CCD) and a complementary metal oxide semiconductor (CMOS). The camera 10 is mounted at arbitrary places on the autonomous vehicle in which the vehicle control device 5 is installed. In the case of capturing an image of an area in front of the autonomous vehicle, the camera 10 is mounted on an upper part of a front windshield, on a rear surface of a rear-view mirror, and the like. The camera 10, for example, periodically and repeatedly captures the surroundings of the autonomous vehicle. The camera 10 may be a stereo camera.

The radar device 12 emits radio waves such as millimeter waves to the surroundings of the autonomous vehicle, detects radio waves (reflected waves) reflected by an object, and detects at least a position (a distance and an orientation) of the object. The radar device 12 is mounted at arbitrary places on the autonomous vehicle. The radar device 12 may detect the position and the speed of the object by a frequency modulated continuous wave (FM-CW) scheme.

The finder 14 is a light detection and ranging (LIDAR). The finder 14 emits light to the surroundings of the autonomous vehicle and measures scattered light. The finder 14 detects a distance to a target on the basis of a time from light emission to light reception. The emitted light is a pulsed laser beam, for example. The finder 14 is mounted at arbitrary places on the autonomous vehicle.

The object recognition device 16 performs a sensor fusion process on results of detection by some or all of the camera 10, the radar device 12, and the finder 14, thereby recognizing the position, the type, the speed and the like of an object. The object recognition device 16 outputs a recognition result to the automatic driving control device 100. The object recognition device 16 may output the detection results of the camera 10, the radar device 12, and the finder 14 to the automatic driving control device 100 as is. The object recognition device 16 may be omitted from the vehicle control device 5.

The communication device 20 communicates with other vehicles present around the autonomous vehicle by using, for example, a cellular network, a Wi-Fi network, Bluetooth (registered trademark), a dedicated short range communication (DSRC), and the like, or communicates with various server devices via a wireless base station.

The HMI 30 presents various types of information to a passenger of the autonomous vehicle and receives an input operation of the passenger. The HMI 30 includes various display devices, speakers, buzzers, touch panels, switches, keys and the like.

The vehicle sensor 40 includes a vehicle speed sensor that detects the speed of the autonomous vehicle, an acceleration sensor that detects an acceleration, a yaw rate sensor that detects an angular velocity around a vertical axis, a direction sensor that detects the direction of the autonomous vehicle, and the like.

The navigation device 50 includes, for example, a global navigation satellite system (GNSS) receiver 51, a navigation HMI 52, and a route determiner 53. The navigation device 50 stores first map information 54 in a storage device such as an HDD and a flash memory. The GNSS receiver 51 identifies the position of the autonomous vehicle on the basis of a signal received from a GNSS satellite. The position of the autonomous vehicle may be specified or supplemented by an inertial navigation system (INS) using the output of the vehicle sensor 40. The navigation HMI 52 includes a display device, a speaker, a touch panel, keys and the like. The navigation HMI 52 may be partially or entirely shared with the aforementioned HMI 30. The route determiner 53 determines, for example, a route (hereinafter, referred to as a route on a map) to a destination, which is input by a passenger using the navigation HMI 52, from the position of the autonomous vehicle specified by the GNSS receiver 51 (or any input position) with reference to the first map information 54. The first map information 54 is, for example, information on a road shape represented by links indicating a road and nodes connected to the links. The first map information 54 may include a road curvature, point of interest (POI) information, and the like. The route on the map is output to an MPU 60. The navigation device 50 may perform route guidance using the navigation HMI 52 on the basis of the route on the map. The navigation device 50 may be implemented by, for example, functions of a terminal device such as a smart phone and a tablet terminal owned by a passenger. The navigation device 50 may transmit the current position and the destination to a navigation server via the communication device 20, and acquire a route equivalent to the route on the map from the navigation server.

The MPU 60 includes, for example, a recommended lane determiner 61 and stores second map information 62 in a storage device such as an HDD and a flash memory. The recommended lane determiner 61 divides the route on the map provided from the navigation device 50 into a plurality of blocks (for example, divides the route on the map every 100 m in the vehicle travel direction), and determines a recommended lane for each block with reference to the second map information 62. The recommended lane determiner 61 determines on which lane numbered from the left to travel. When there is a branch point on the route on the map, the recommended lane determiner 61 determines a recommended lane such that the autonomous vehicle can travel on a reasonable route for traveling to a branch destination.

The second map information 62 is more accurate map information than the first map information 54. The second map information 62 includes, for example, information on the center of a lane, information on the boundary of the lane, and the like. Furthermore, the second map information 62 may include road information, traffic regulation information, address information (address and postal code), facility information, telephone number information, and the like. The second map information 62 may be updated at any time by the communication device 20 communicating with another device.

The in-vehicle camera 70 is, for example, a digital camera using a solid-state imaging element such as a CCD and a CMOS. The in-vehicle camera 70 is mounted at arbitrary places for capturing the interior of the autonomous vehicle.

The driving operator 80 includes, for example, an accelerator pedal, a brake pedal, a shift lever, steering wheel, a deformed steer, a joy stick, and other operators. The driving operator 80 is provided with a sensor for detecting an operation amount or the presence or absence of an operation, and its detection result is output to the automatic driving control device 100, or some or all of the travel driving force output device 200, the brake device 210, and the steering device 220.

The automatic driving control device 100 includes, for example, a first controller 120 and a second controller 160. Each of the first controller 120 and the second controller 160 is implemented by, for example, a hardware processor such as a CPU that executes a program (software). Furthermore, some or all of these components may be implemented by hardware (a circuit unit: including circuitry) such as an LSI, an ASIC, a FPGA, and a GPU, or may be implemented by software and hardware in cooperation. The program may be stored in advance in a storage device such as an HDD and a flash memory of the automatic driving control device 100, or may be installed in the HDD and the flash memory of the automatic driving control device 100 when a detachable storage medium storing the program, such as a DVD and a CD-ROM, is mounted on a drive device.

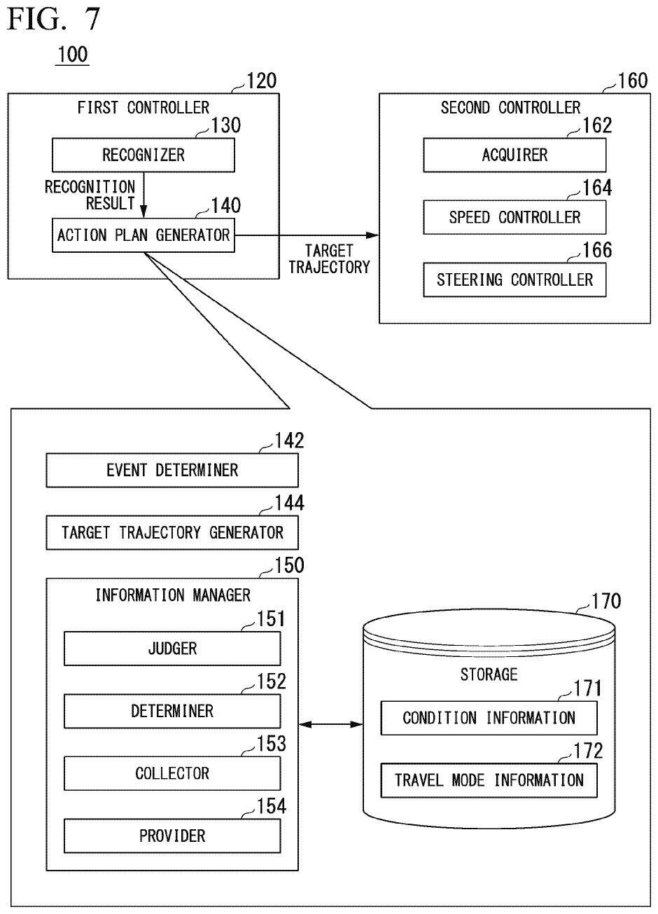

FIG. 7 is a functional configuration diagram of the first controller 120 and the second controller 160. The first controller 120 includes, for example, a recognizer 130 and an action plan generator 140. The first controller 120 performs, for example, a function based on an artificial intelligence (AI) and a function based on a predetermined model in parallel. For example, a function of “recognizing an intersection” may be implemented by performing intersection recognition by deep learning and the like and recognition based on a predetermined condition (such as a signal that can be subjected to pattern matching, road markings, and the like) in parallel, or scoring both recognition and comprehensively evaluating them. With this, the reliability of automatic driving is ensured.

The recognizer 130 recognizes a state such as the position, speed, and acceleration of an object around the autonomous vehicle on the basis of information input from the camera 10, the radar device 12, and the finder 14 via the object recognition device 16. The position of the object is recognized, for example, as a position on absolute coordinates with a representative point (a centroid, a driving axis center, and the like) of the autonomous vehicle as the origin, and is used for control. The position of the object may be represented by a representative point of a centroid, a corner and the like of the object, or may be represented by an indicated area. The “state” of the object may include an acceleration, a jerk, or an “action state” (for example, whether lane change is being performed or is intended to be performed) of the object.

Furthermore, the recognizer 130 recognizes, for example, a lane (a travel lane) on which the autonomous vehicle is traveling. For example, the recognizer 130 compares a pattern (for example, an arrangement of solid lines and broken lines) of road marking lines obtained from the second map information 62 with a pattern of road marking lines around the autonomous vehicle, which is recognized from the image captured by the camera 10, thereby recognizing the travel lane. Note that the recognizer 130 may recognize not only the road marking lines but also a traveling road boundary (road boundary) including the road marking lines, a road shoulder, a curb, a median strip, a guardrail, and the like, thereby recognizing the travel lane. In this recognition, the position of the autonomous vehicle acquired from the navigation device 50 or processing results of the INS may be taken into consideration. The recognizer 130 recognizes a temporary stop line, an obstacle, a red light, a tollgate, and other road events.

When recognizing the travel lane, the recognizer 130 recognizes the position and the orientation of the autonomous vehicle with respect to the travel lane. The recognizer 130, for example, may recognize, as the relative position and the orientation of the autonomous vehicle with respect to the travel lane, a deviation of a reference point of the autonomous vehicle from a center of a lane and an angle formed between the progress direction of the autonomous vehicle and a line connecting along the center of the lane. Alternatively, the recognizer 130 may recognize the position and the like of the reference point of the autonomous vehicle with respect to any one of the side ends (the road marking line or the road boundary) of the travel lane as the relative position of the autonomous vehicle with respect to the travel lane.

The action plan generator 140 includes, for example, an event determiner 142, a target trajectory generator 144, an information manager 150, and a storage 170. The storage 170 is, for example, a RAM, a ROM, a flash memory such as an SSD, an HDD, and the like. The storage 170 stores, for example, information such as condition information 171 and travel mode information 172. The condition information 171 and the travel mode information 172 will be described below.

The event determiner 142 determines events for automatic driving on the route for which the recommended lane has been determined. The events are information that define travel modes of the autonomous vehicle. The events for automatic driving include constant speed travel events, low speed following travel events, lane change events, branch events, merge events, takeover events, and the like. Furthermore, the event determiner 142 may change the already determined event to another event or newly determine an event according to the surrounding situation recognized by the recognizer 130 while the autonomous vehicle is traveling.

The target trajectory generator 144 generates a future target trajectory along which the autonomous vehicle will travel in the travel modes defined by the events automatically (independent of a driver's operation) so as to allow the autonomous vehicle to travel on the recommended lane determined by the recommended lane determiner 61 in principle and further to cope with surrounding situations while the autonomous vehicle is traveling on the recommended lane. The target trajectory includes, for example, a position element that defines the future position of the autonomous vehicle and a speed element that defines the future speed and the like of the autonomous vehicle. For example, the target trajectory generator 144 generates a target trajectory corresponding to an event activated by the event determiner 142.

For example, the target trajectory generator 144 determines, as the position element of the autonomous vehicle, a plurality of points (trajectory points) to be reached in sequence by the autonomous vehicle. The trajectory points are points that the autonomous vehicle should reach for each of predetermined travel distances (for example, about every several [m]). The predetermined travel distance may be calculated by, for example, a distance along a road when traveling along a route.

For example, the target trajectory generator 144 determines a target speed and a target acceleration at each predetermined sampling time (for example, about every several tenths of a [sec]) as the speed element of the target trajectory. Furthermore, the trajectory point at each predetermined sampling time may be a position that the autonomous vehicle will reach at each sampling time. In such a case, the target speed and the target acceleration are determined by the sampling time and the interval between the trajectory points. The target trajectory generator 144 outputs information indicating the generated target trajectory to the second controller 160.

The information manager 150 includes a judger 151, a determiner 152, a collector 153, and a provider 154. Some or all of the judger 151, the determiner 152, the collector 153, and the provider 154 are implemented by, for example, a processor such as a CPU that executes a program (software) stored in the storage 170. Furthermore, some or all of these components may be implemented by hardware (a circuit unit: including circuitry) such as an LSI, an ASIC, a field-programmable gate array (FPGA), and a graphics processing unit (GPU), or may be implemented by software and hardware in cooperation.

The information manager 150 allows the autonomous vehicle to travel in travel modes (hereinafter, referred to as first travel modes) determined as travel modes for acquiring the collection information. The first travel mode is different from a travel mode (hereinafter, referred to as a second travel mode) in a state in which a passenger is in the autonomous vehicle. The second travel mode includes, for example, efficiently traveling to a destination set by the passenger, maintaining a set vehicle interior temperature, allowing the guidance result of navigation device 50 to be output from the 30 HMI 30, and the like. By setting the first travel mode to be different from the second travel mode, for example, it is possible to freely travel to a desired place for acquiring the collection information regardless of the destination set by the passenger.

The judger 151 refers to the storage 170 and judges whether there is a situation for acquiring the collection information. For example, when collection conditions are satisfied, the judger 151 judges that there is a situation for acquiring the collection information. The collection conditions include, for example, the following collection conditions 1 to 5. The collection condition 1 refers to a state in which the autonomous vehicle can travel without any passengers. The collection condition 2 is that time information satisfies an environment condition determined in advance as an acquisition environment of the collection information. The collection condition 3 is that weather information satisfies the environment condition determined in advance as the acquisition environment of the collection information. The collection condition 4 is that a period in which the autonomous vehicle can be used to collect the collection information is a predetermined time or more. The collection condition 5 is that the position of the autonomous vehicle is included in an area for collecting the collection information. Note that the content and combination of the conditions included in the collection conditions can be arbitrarily set according to the type of the collection information to be acquired, a travel time period and a travel area of the autonomous vehicle, and the like.

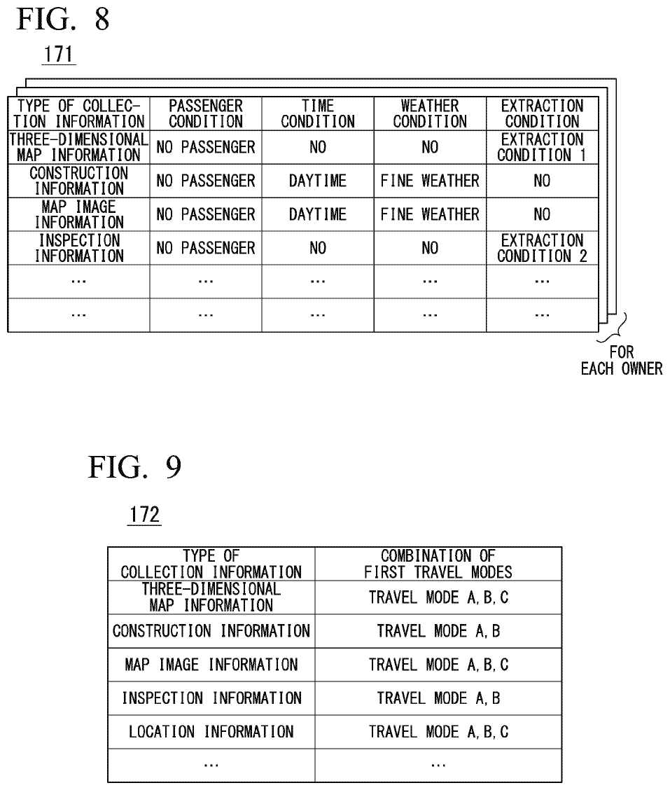

The collection conditions are set in the condition information 171, for example. FIG. 8 is a diagram illustrating an example of the content of the condition information 171. As illustrated in FIG. 8, the condition information 171 is information in which the type of collection information is correlated with passenger conditions, time conditions, weather conditions, and extraction conditions. The passenger conditions are information indicating the content of the collection condition 1 and the presence or absence of application of the collection condition 1. The time conditions are information indicating the content of the collection condition 2 and the presence or absence of application of the collection condition 2. The weather conditions are information indicating the content of the collection condition 3 and the presence or absence of application of the collection condition 3. By setting the passenger conditions, it is possible to implement traveling for acquiring the collection information without considering traveling to the destination set by the passenger, and the like. Setting the time conditions and the weather conditions is effective when the time and the weather are suitable for acquiring the collection information. Note that the condition information 171 is not limited thereto and may include a period condition for setting the collection condition 4, an area condition for setting the collection condition 5, and the like.

The extraction conditions are information indicating extraction conditions of the collection information. The extraction conditions include, for example, the following extraction conditions 1, 2 and the like. The extraction condition 1 is that the autonomous vehicle is traveling in an area where comparison results of a map indicated by the information acquired by the information acquirer 15 is different from a map prepared in advance as a comparison target. The extraction condition 2 is that the autonomous vehicle is traveling in an area around a search target. By setting the extraction condition 1, it is possible to extract, as the collection information, only map information of an area different from an existing map or only a map of an area not included in the existing map. By setting the extraction condition 2, it is possible to extract, as the collection information, only collection information including the search target.

For example, on the basis of an image captured by the in-vehicle camera 70, the judger 151 judges whether the collection condition 1 is satisfied. On the basis of the output from the clock 72, the judger 151 judges whether the collection condition 2 is satisfied. On the basis of the weather information received from the information providing server 900 by using the communication device 20, the judger 151 judges whether the collection condition 3 is satisfied. Note that the judger 151 may communicate with the information management device 500 and judge whether there is a period in which the collection conditions are satisfied in a schedule registered in advance by the owner X.

Furthermore, the judger 151 refers to the condition information 171 and judges whether the extraction conditions are satisfied, on the basis of the situation information acquired by the information acquirer 15. The judger 151 outputs a judgment result to the collector 153.

The determiner 152 refers to the storage 170 and determines the first travel modes according to the judgment result of the judger 151. The first travel mode is determined according to the type of the collection information, for example. FIG. 9 is a diagram illustrating an example of the content of the travel mode information 172. As illustrated in FIG. 9, the travel mode information 172 is information in which the type of the collection information is correlated with a combination of the first travel modes. The content and combination of the first travel modes are determined for each type of the collection information. For example, when the type of the collection information is the “three-dimensional map information”, the first travel modes include all of travel modes A to C. When the type of the collection information is the “construction information”, the first travel modes may include the travel modes A and C.

The first travel modes include, for example, the following travel modes A to C. The travel mode A is to allow the autonomous vehicle to travel without operating the air conditioning equipment 74 installed in the autonomous vehicle. The travel mode B is to allow the autonomous vehicle to travel in a behavior corresponding to a target (hereinafter, referred to as an information acquisition target) from which the collection information is acquired. The travel mode C is to wait until there is no person around the autonomous vehicle and then to allow the autonomous vehicle to travel in a behavior for acquiring the collection information.

The information acquisition target differs according to the type of the collection information, for example. When the type of the collection information is the three-dimensional map information or the map image information, the information acquisition target includes structures or buildings on the shoulder of a road on which the autonomous vehicle travels, the surroundings of the autonomous vehicle, and the like. When the type of the collection information is the construction information, the information acquisition target includes signs, structures and the like installed at a construction site. When the type of the collection information is the inspection information, the information acquisition target includes an inspection target and the like set by a customer. When the type of the collection information is the location information, the information acquisition target includes structures, landscapes and the like that a customer is looking for.

The behaviors corresponding to the information acquisition target include, for example, traveling close to the information acquisition target, slowly traveling in the vicinity of the information acquisition target, coming and going repeatedly in the vicinity of the information acquisition target, turning the steering of the autonomous vehicle such that an angle of the autonomous vehicle with respect to the information acquisition target varies, traveling while searching for the information acquisition target, and the like. By so doing, it is possible to allow the autonomous vehicle to behave in a manner that facilitates acquisition of the collection information, depending on the information acquisition target.

The behaviors for acquiring the collection information also include a behavior independent of the information acquisition target, in addition to the behaviors corresponding to the information acquisition target as described above. Behavior independent of the information acquisition target include, for example, behavior corresponding to vehicles around the autonomous vehicle, passersby, and the like.

According to the travel mode A, even when power required for a process of acquiring the collection information is large, it is possible to reduce power consumption due to the air conditioning equipment 74, so that it is possible to reduce overall power consumption of the autonomous vehicle. According to the travel mode B, it is possible to implement a travel mode corresponding to the form of the information acquisition target and a travel mode corresponding to the type of the collection information, so that it is possible to acquire information that is not acquirable in a travel mode with a passenger on board and put the information into the collection information. According to the travel mode C, it is possible to acquire the collection information in a state in which there are no passers-by, so that it is possible to improve the quality of the collection information.

The determiner 152 instructs the navigation device 50 to determine a route to a destination on the basis of the first travel modes. With this, the MPU 60 determines a recommended lane according to the first travel modes, the event determiner 142 determines an event according to the first travel modes, or the target trajectory generator 144 generates a target trajectory according to the first travel modes. The second controller 160 controls each device on the basis of the information output from the first controller 120 by such processing, so that the autonomous vehicle can travel on the basis of the first travel modes.

The collector 153 collects, as the collection information, the situation information acquired by the information acquirer 15 in relation to a situation satisfying the collection conditions. For example, the collector 153 acquires, as the collection information, the situation information acquired by the information acquirer 15 in the same period as a period in which the judger 151 judges that the situation satisfies the collection conditions. Furthermore, the collector 153 may extract, as the collection information, situation information satisfying the extraction conditions from the situation information acquired by the information acquirer 15 in the same period as the period in which the judger 151 judges that the situation satisfies the collection conditions.

The provider 154 transmits the collection information extracted by the collector 153 to a server device of a customer by using the communication device 20.

The second controller 160 controls the travel driving force output device 200, the brake device 210, and the steering device 220 such that the autonomous vehicle passes along the target trajectory generated by the action plan generator 140 at scheduled times.

Returning to FIG. 7, the second controller 160 includes, for example, an acquirer 162, a speed controller 164, and a steering controller 166. The acquirer 162 acquires information on the target trajectory (trajectory points) generated by the action plan generator 140 and stores the information in a memory (not illustrated). The speed controller 164 controls the travel driving force output device 200 or the brake device 210 on the basis of a speed element associated with the target trajectory stored in the memory. The steering controller 166 controls the steering device 220 according to the degree of bending of the target trajectory stored in the memory. The processes of the speed controller 164 and the steering controller 166 are implemented by, for example, a combination of feedforward control and feedback control. As an example, the steering controller 166 performs a combination of feedforward control corresponding to the curvature of a road in front of the autonomous vehicle and feedback control based on a deviation from the target trajectory.

The travel driving force output device 200 outputs a travel driving force (torque) for driving the vehicle to driving wheels. The travel driving force output device 200, for example, includes a combination of an internal combustion engine, an electric motor, a transmission and the like, and an electronic control unit (ECU) for controlling them. The ECU controls the aforementioned configuration according to information input from the second controller 160 or information input from the driving operator 80.

The brake device 210, for example, includes a brake caliper, a cylinder for transferring hydraulic pressure to the brake caliper, an electric motor for generating the hydraulic pressure in the cylinder, and a brake ECU. The brake ECU controls the electric motor according to the information input from the second controller 160 or the information input from the driving operator 80, thereby allowing a brake torque corresponding to a brake operation to be output to each wheel. The brake device 210 may have a backup mechanism for transferring the hydraulic pressure generated by an operation of the brake pedal included in the driving operator 80 to the cylinder via a master cylinder. Note that the brake device 210 is not limited to the aforementioned configuration and may be an electronically controlled hydraulic pressure brake device that controls an actuator according to the information input from the second controller 160, thereby transferring the hydraulic pressure of the master cylinder to the cylinder.

The steering device 220, for example, includes a steering ECU and an electric motor.

The electric motor, for example, changes a direction of a steering wheel by allowing a force to act on a rack and pinion mechanism. The steering ECU drives the electric motor according to the information input from the second controller 160 or the information input from the driving operator 80, thereby changing the direction of the steering wheel.

[Processing Flow]

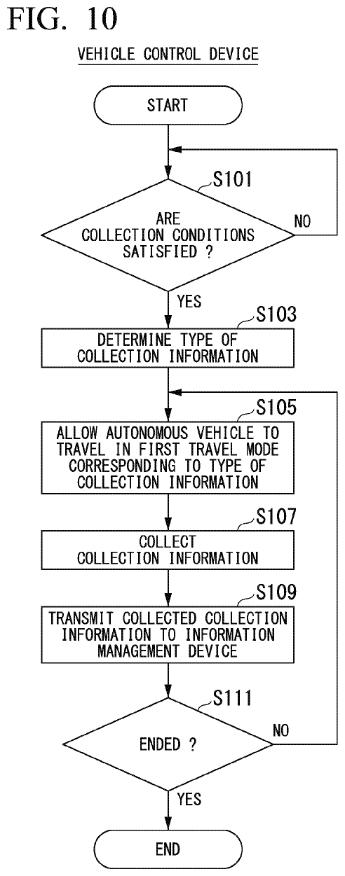

Hereinafter, the flow of each processing by the vehicle control device 5 of an embodiment will be described with reference to a flowchart. FIG. 10 is a flowchart illustrating an example of the flow of processing by the vehicle control device 5. The processing of the present flowchart is performed in each autonomous vehicle.

First, the judger 151 judges whether the collection conditions are satisfied (step S101). When it is judged that the collection conditions are satisfied, the determiner 152 determines types of collection information (step S103). When there is one type of the collection information satisfying the collection conditions, the determiner 152 determines the type of the collection information. When there are two or more types of the collection information satisfying the collection conditions, the determiner 152 determines a type on the basis of, for example, a priority order set in advance by the owner X in the collection information. The determiner 152 refers to the travel mode information 172, determines the first travel mode corresponding to the determined type of the collection information, and allows the autonomous vehicle to travel according to the determined first travel mode (step S105).

Next, the collector 153 acquires, as the collection information, the information acquired by the information acquirer 15 in the same period as a period in which the autonomous vehicle travels in the first travel mode (step S107). In step S107, when the extraction conditions have been set, the collector 153 may extract information matching the extraction conditions from the acquired collection information, and use the extracted information as the collection information. Note that the collector 153 may extract the collection information at the same time as the period in which the autonomous vehicle is traveling in the first travel mode, or extract the collection information in a state in which the autonomous vehicle is stopped or parked after the traveling in the first travel mode is ended. By employing the former method, it is possible to provide a customer with the collection information in near real time. By employing the latter method, it is possible to distribute a load on the autonomous vehicle. Then, the provider 154 transmits the collection information acquired by the collector 153 to the customer management server 700 (step S109). Then, the information manager 150 returns to step S105 and repeats the processing until the period of traveling in the first travel mode is ended (step S111).

The first embodiment described above includes the information acquirer (15) that acquires situation information indicating the situation of the surroundings of the autonomous vehicle, the collector (153 or 526) that collects, from the situation information acquired by the information acquirer, first situation information acquired by the information acquirer in relation to a situation satisfying predetermined conditions including that the autonomous vehicle is traveling without any passengers, and the controllers (120 and 160) that allow the autonomous vehicle to travel in the first travel mode determined in advance for acquiring the first situation information, so that it is possible to acquire collection information by utilizing the information acquirer 15 installed in the autonomous vehicle. Thus, the owner X can obtain a profit by selling the acquired collection information to a customer. By so doing, it is possible to expand the range of use of the autonomous vehicle.

### Second Embodiment

Next, a vehicle control system according to a second embodiment will be described. Hereinafter, differences from the vehicle control system 1 according to the first embodiment will be described and description of the same functions and configurations will be omitted.

[Information Management Device 500A]

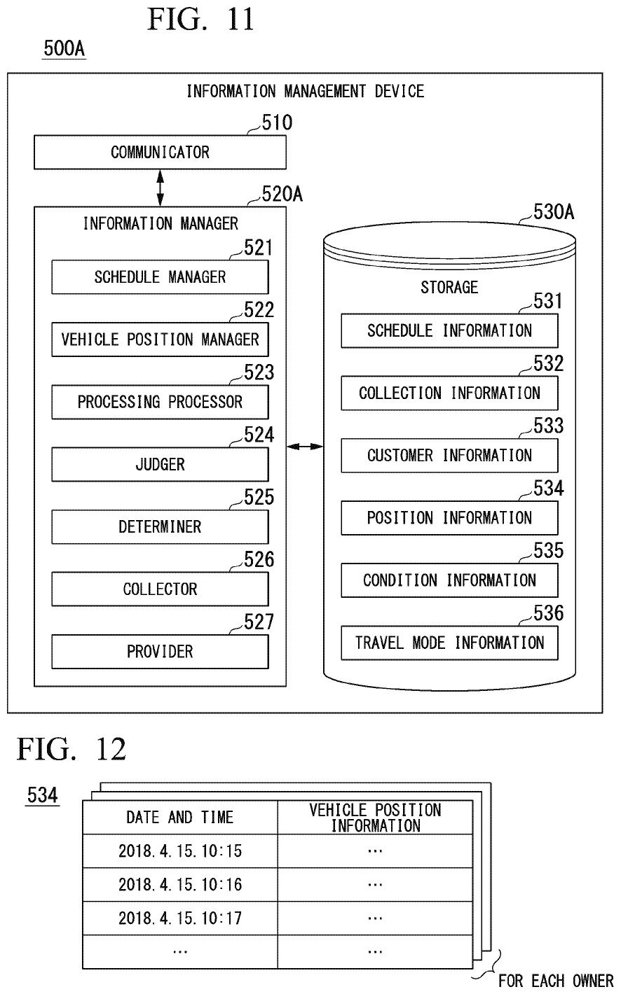

FIG. 11 is a configuration diagram of the information management device 500A. The information management device 500A includes the communicator 510, an information manager 520A, and a storage 530A. The storage 530A stores, for example, information such as position information 534, condition information 535, and travel mode information 536, in addition to the schedule information 531, the collection information 532, and the customer information 533. The condition information 535 and the travel mode information 536 are the same information as the aforementioned condition information 171 and travel mode information 172, respectively.

The position information 534 is information indicating the position of the autonomous vehicle. FIG. 12 is a diagram illustrating an example of the content of the position information 534. As illustrated in FIG. 12, the position information 534 is information in which vehicle position information is correlated with a date and time. The vehicle position information is information indicating the position of the autonomous vehicle acquired by the navigation device 50.

The information manager 520A includes a vehicle position manager 522, a judger 524, a determiner 525, and a collector 526, in addition to the schedule manager 521, the processing processor 523, and the provider 527. The judger 524, the determiner 525, and the collector 526 have the same functions as the judger 151, the determiner 152, and the collector 153 described above. The vehicle position manager 522 updates the position information 534 on the basis of position information received from the vehicle control device 5 by using the communicator 510. The judger 524 may refer to the position information 534, extract the autonomous vehicle satisfying the area condition included in the condition information 171, and output an extraction result to the determiner 525. By so doing, it is possible to request the autonomous vehicle, which is traveling in an area defined in the area condition, to collect collection information.

[Processing Flow]

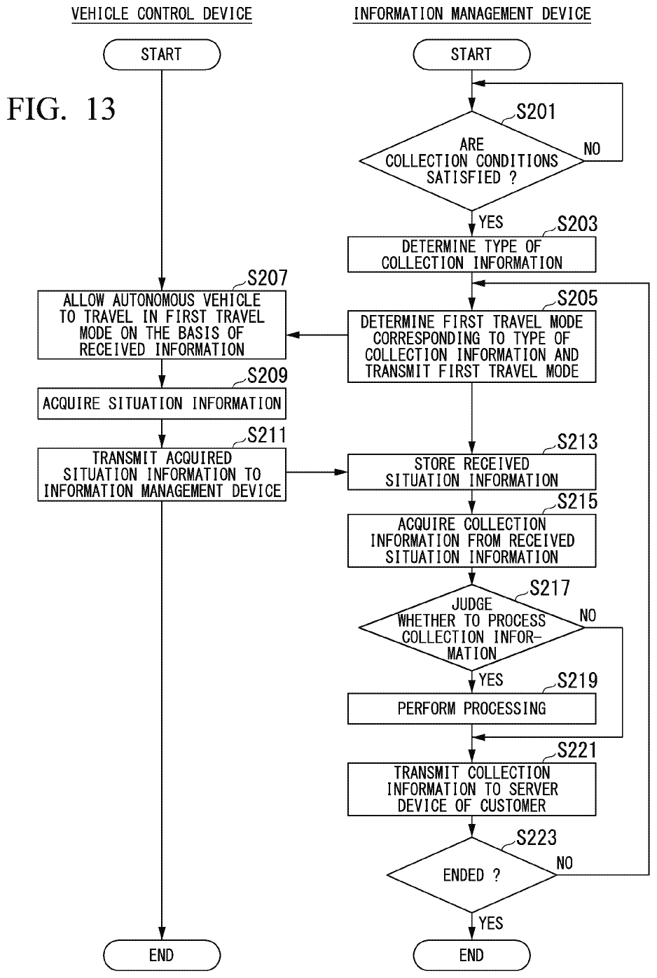

Hereinafter, the flow of each processing by the vehicle control device 5 and the information management device 500 of an embodiment will be described with reference to a flowchart. FIG. 13 is a flowchart illustrating an example of the flow of processing by the vehicle control device 5 and the information management device 500. The processing of the present flowchart is performed in each autonomous vehicle.

First, the judger 524 judges whether the collection conditions are satisfied (step S201). When it is judged that the collection conditions are satisfied, the determiner 525 determines types of collection information (step S203). The determiner 525 refers to the travel mode information 536, determines the first travel mode corresponding to the determined type of the collection information, and transmits information indicating the determined first travel mode to the vehicle control device 5 (step S205).

On the basis of the received information, the vehicle control device 5 allows the autonomous vehicle to travel according to the first travel mode (step S207). In a period in which the autonomous vehicle is traveling in the first travel mode, the information acquirer 15 acquires situation information (step S209). The provider 527 transmits the situation information acquired by the information acquirer 15 to the information management device 500 (step S211).

The information management device 500 stores the situation information received from the vehicle control device 5 in the storage 530A (step S213). The collector 526 acquires collection information from the situation information stored in the storage 530A (step S215). Here, the collector 526 may acquire all or some of the situation information received from the vehicle control device 5 as the collection information.

Next, the processing processor 523 judges whether to perform processing on the collection information extracted by the collector 526 (step S217). When a customer desires to perform the processing, the processing processor 523 performs the processing on the collection information (step S219). Then, the provider 527 transmits the collection information to the customer management server 700 (step S221). Then, the information manager 520A returns to step S205 and repeats the processing until the period of traveling in the first travel mode is ended (step S223).

According to the second embodiment described above, it is possible to obtain the same effects as in the vehicle control system 1 according to the first embodiment.

[Hardware Configuration]

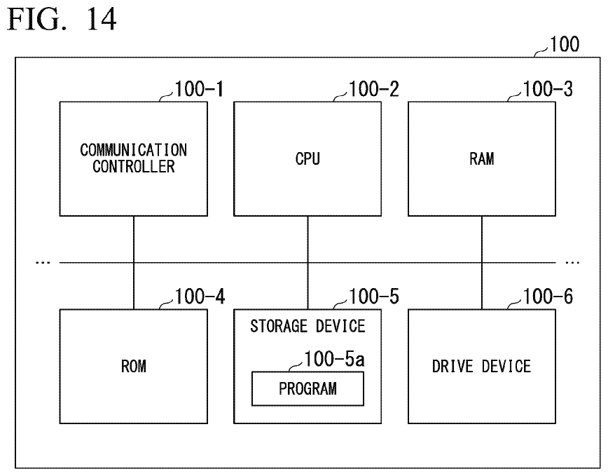

FIG. 14 is a diagram illustrating an example of a hardware configuration of the automatic driving control device 100 of an embodiment. As illustrated in FIG. 14, the automatic driving control device 100 has a configuration in which a communication controller 100-1, a CPU 100-2, a RAM 100-3 used as a working memory, a ROM 100-4 for storing a boot program and the like, a storage device 100-5 such as a flash memory and an HDD, a drive device 100-6, and the like are connected to each other by an internal bus or a dedicated communication line. The communication controller 100-1 communicates with components other than the automatic driving control device 100.

The storage device 100-5 stores a program 100-5a that is executed by the CPU 100-2. The program is developed to the RAM 100-3 by a direct memory access (DMA) controller (not illustrated) and the like, and is executed by the CPU 100-2. With this, some or all of the first controller 120 and the second controller 160 are implemented.

Although a mode for carrying out the present invention has been described using the embodiments, the present invention is not limited to these embodiments and various modifications and substitutions can be made without departing from the spirit of the present invention.

For example, the determiners 152 and 525 may determine the type of the collection information on the basis of the settings of the owner X. For example, when only one type of the collection information is set by the owner X, the determiners 152 and 525 determine the set type of the collection information. When a plurality of types of the collection information are set by the owner X, the determiners 152 and 525 may determine an optimal type of the collection information on the basis of environmental conditions when acquiring the collection information. For example, the determiners 152 and 525 determine the optimal type of the collection information in accordance with a time period for collecting the collection information, the length thereof, and the like.

The vehicle control device 5 may receive a request as a mobile resource from the information management device 500, for example. For example, the judgers 151 and 524 judge that the collection conditions are satisfied when a request as a mobile resource is received from the information management device 500 (for example, when information on subsequent occurrence is received). The determiners 152 and 525 determine the type of the collection information and the first travel mode on the basis of the received information.

The vehicle control device 5 may directly receive a request as a mobile resource from a customer's terminal device 300 without the intervention of the information management device 500, for example. For example, when a request of the owner X is received from the terminal device 300, the judgers 151 and 524 judge that the collection conditions are satisfied. The determiners 152 and 525 determine the type of the collection information and the first travel mode on the basis of the request of the owner X received from the terminal device 300.

Furthermore, the information manager 150 and various types of information described above may be implemented by executing an application program. The vehicle control device 5 downloads the application program from the information management device 500, for example.

Furthermore, the processing processor 523 may generate more accurate collection information on the basis of collection information received from a plurality of vehicle control devices 5. For example, the processing processor 523 may generate more accurate construction information on the basis of construction information collected from a plurality of vehicle control devices 5. Furthermore, the processing processor 523 may generate more accurate collection information by generating a normal distribution or deriving a maximum value and a minimum value on the basis of collection information collected from a plurality of vehicle control devices 5.

Furthermore, although the example in which the “information acquirer” is the “information acquirer 15” has been described, the information acquirer may be provided in the information management device 500 or may include the information acquirer 15 and the information acquirer provided in the information management device 500. In such a case, the information acquirer provided in the information management device 500 acquires situation information from the information acquirer 15 installed in the vehicle control device 5.

### REFERENCE SIGNS LIST

1 Vehicle control system

5 Vehicle control device

300 Terminal device

500 Information management device

700 Customer management server

900 Information providing server

10 Camera

12 Radar device

14 Finder

16 Object recognition device

20 Communication device

30 HMI

40 Vehicle sensor

50 Navigation device

60 MPU

70 In-vehicle camera

72 Clock

74 Air conditioning equipment

80 Driving operator

100 Automatic driving control device

120 First controller

130 Recognizer

140 Action plan generator

142 Event determiner

144 Target trajectory generator

150 Information manager

151 Judger

152 Determiner

153 Collector

154 Provider

160 Second controller

162 Acquirer

164 Speed controller

166 Steering controller

200 Travel driving force output device

210 Brake device

220 Steering device

What is claim is:

1. A vehicle control system comprising:
an information acquirer configured to acquire situation information indicating a situation of surroundings of an autonomous vehicle;
a collector configured to collect first situation information from the situation information acquired by the information acquirer; and
a controller configured to allow the autonomous vehicle to travel in a first travel mode determined in advance for acquiring the first situation information,
wherein the first situation information is information acquired by the information acquirer in relation to a situation satisfying a predetermined condition including that the autonomous vehicle is traveling without any passengers.

2. The vehicle control system according to claim 1, wherein the first travel mode is different from a second travel mode in a state in which a passenger is in the autonomous vehicle.

3. The vehicle control system according to claim 1, wherein the first travel mode includes allowing the autonomous vehicle to travel without operating air conditioning equipment installed in the autonomous vehicle.

4. The vehicle control system according to claim 1, wherein the first travel mode includes allowing the autonomous vehicle to travel in a behavior corresponding to a target from which the situation information is acquired.

5. The vehicle control system according to claim 1, wherein the first travel mode includes waiting a situation until there is no person around the autonomous vehicle and allowing the autonomous vehicle to travel in a behavior for acquiring the first situation information.

6. The vehicle control system according to claim 1, wherein the predetermined condition includes that at least one of time information and weather information satisfies an environmental condition determined in advance as an acquisition environment of the first situation information.

7. The vehicle control system according to claim 1, wherein the controller determines the first travel mode on the basis of information received from an external device by using a communicator.

8. The vehicle control system according to claim 1, further comprising:
a judger configured to judge whether a collection condition of the first situation information is satisfied, on the basis of the situation information acquired by the information acquirer,
wherein the collector collects the first situation information on the basis of a judgment result of the judger.

9. The vehicle control system according to claim 8, wherein the judger judges that the collection condition of the first situation information is satisfied when traveling a place where a map indicated by the situation information acquired by the information acquirer is different from a map prepared in advance as a comparison target.

10. A vehicle control method implemented by at least one computer performing the steps of:
collecting, from situation information acquired by an information acquirer that acquires situation information indicating a situation of surroundings of an autonomous vehicle, first situation information acquired by the information acquirer in relation to a situation satisfying a predetermined condition including that the autonomous vehicle is traveling without any passengers; and
allowing the autonomous vehicle to travel in a first travel mode determined in advance for acquiring the first situation information.

11. A computer-readable non-temporary storage medium storing a program causing at least one computer to perform the steps of:
collecting, from situation information acquired by an information acquirer that acquires the situation information indicating a situation of surroundings of an autonomous vehicle, first situation information acquired by the information acquirer in relation to a situation satisfying a predetermined condition including that the autonomous vehicle is traveling without any passengers; and
allowing the autonomous vehicle to travel in a first travel mode determined in advance for acquiring the first situation information.
